(19) United States
(12) Patent Application Publication
(10) Pub. No.: US 2009/0111074 A1
(43) Pub. Date: Apr. 30, 2009

(54) COMPUTERIZED CONTENT-ENRICHED ENVIRONMENT FOR CHILDREN

(76) Inventor: Shay SHAHAL, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/261,082

(22) Filed: Oct. 30, 2008

Related U.S. Application Data
(60) Provisional application No. 60/983,579, filed on Oct. 30, 2007.

(51) Int. Cl. G09B 19/22; G09B 25/00

(52) U.S. Cl. 434/128; 434/365

(57) ABSTRACT

A computerized content-enriched environment (CCEE) for children, adapted to increase challenges to curiosity (CTC) of children is disclosed. The confidence of the children is thereby increased. The computerized content-enriched environment comprises a plurality of themed interactive computerized stimulators, operators and sensors within a themed safe environment. A portion of the plurality of themed interactive computerized stimulators, operators and sensors mediate on screen activities in the CCEE and a portion of the themed plurality of stimulators, operators and sensors mediate off screen activities in the CCEE. The themes are essentially similar or identical for both on screen and off screen stimulators, operators and sensors. The CCEE comprises a plurality of corners selected from a group comprising senses corner, music corner and cognitive corner.

### CROSS REFERENCE TO RELATED APPLICATIONS

This Application claims priority to U.S. Provisional Patent Application No. 60/983,579, filed Oct. 30, 2007, the contents of which are incorporated herein by reference in their entirety.

### FIELD OF THE INVENTION

This invention relates educational play areas for toddlers and children.

### BACKGROUND OF THE INVENTION

Toddlers in the developed world are perceived by most parents to require safe environments to play in, where they may be observed and supervised by their care givers. They also need to be stimulated in a positive and beneficial way. A long felt need would be fulfilled if play environments were provided which are both safe and educationally stimulating. A further long felt need would be fulfilled if the 3C Developmental Cycle (Curiosity, Challenge and Confidence) were reinforced by the play environment.

### BRIEF DESCRIPTION OF THE FIGURES

The objects and advantages of various embodiments of the invention will become apparent from the following description when read in conjunction with the accompanying drawings wherein:

FIG. 1 is a depiction of a preferred embodiment of the invention.

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a computerized content-enriched environment (CCEE) for children. The CCEE is adapted to increase challenges to curiosity (CTC) of said children, thereby increasing their confidence and maximising their learning.

These elements (challenge, curiosity and confidence) are reflected in both the contents and design of the invention. The CCEE complex has an outer design of 3 “C” sections, each presenting a different theme corner—Senses Corner, Music Corner, Cognitive Corner, in a maze-like structure, attracting the toddler to go through the different corners, providing a dynamic mental and physical voyage of investigation and exploration.

The visual and graphic content of the CCEE is similarly themed for both on screen and off screen activities with friendly characters and motives, presented all around the complex. The CCEE complex has several child friendly PC stations, including a fun colourful wooden car, Comfy software line for multi users and Easy PC keyboard—all designed especially for children at the ages of 1-5 years to fit into a space of about one square meter. The system operates on a standard PC with DVD drive. The games are freely selectable, according to various age-groups and it is possible to select the games desired language from 19 different languages available.

The whole CCEE complex has been designed with 3 outer “C” sections, each presenting a different theme corner namely the Senses Corner, Music Corner, Cognitive Corner, in a maze-like structure. The toddler is attracted to go through the different corners, and the CCEE provides a dynamic, mental and physical voyage of investigation and exploration.

The term “Comfy” or “Comfy Theme” or “Comfyland Experience” or the prefix “Comfy” associated with other words or phrases hereinafter refers herein to the whole visual and graphic environment of a vivid cartoon animated world of the Comfy Easy PC—award winning interactive system (see comfyland.eu/characters and comfyland.com. The purpose of the Comfyland experience is to enable young toddlers, from 12 months, to enjoy the rich and exciting world of computers, with its friendly characters and motives, presented all around the complex. All the themes of the invention are associated with Comfy.

It is acknowledged that the term “stimulator(s)” refers herein to an element or component within the embodiments whose purpose and effect is to rouse to action or effort, as by encouragement or pressure; spur on or incite: In some embodiments the stimulator could be selected from a group consisting of display screens, lights and illuminating means, vibrating means, rocking means, audio means, video means, tactile means, olfactory means, test means, loud speakers, robots, toys, avatars, pets and pet-like modules, ball games and racquets thereof, vehicles, maneuverable units,

It is acknowledged that the term “operator(s)” refers herein to an element or component effected to bring about a result or event. In some embodiments the operator could be selected from a group consisting of buttons, levers, keyboards, remote controls, sliders, touch screens, audio-operatable means, joy-sticks, steering wheels, handles, triggers.

It is acknowledged that the term “sensor(s)” refers herein to a mechanical device sensitive to light, temperature that transmits a signal to a measuring or control instrument or a device, such as a photoelectric cell, that receives and responds to a signal or stimulus in some embodiments of the invention the sensor may be selected from a group consisting of temperature, vocal, weight, touch, impedance, light, volume detectors, vibration detectors, accelerometers,

Embodiments of activity corners include:

The Senses Corner—Play, Experience & Learn Through the Senses

The first years of a child's life are characterized by the learning & exploration of the world around him, through the senses of sight, touch, smell, hearing and taste. These senses are the primary channels through which the child can gather and process information from his surrounding environment.

In the Senses Corner the child is exposed to an experience of all the senses apart from taste. Each activity has been thought out to focus on one or more senses to explore and reveal some exciting activities.

Another example of the activities provided in the CCEE is Comfy's Surprise Cupboard, which has various doors opening in different ways. Again this activity integrates Comfy's educational approach (3C developmental Cycle), where the game first stimulates the curiosity of the child—(what is hidden behind the door?) challenges it—(how does the door open?) and inspires self confidence—when the child opens the door and reveals the surprise hidden behind it and can repeat this action over again with confidence & enjoyment.

This activity is strongly based on the touch sense, where each surprise represents a different material & texture taken from his environment. This activity also develops visual perception, fine motor skill, the ability to categorize and draw of conclusions.

Surprise Cupboard

A unique activity that includes 9 different door openings. This activity is strongly based on the touch sense, where each surprise represents a different material and texture taken from our day to day surroundings. This activity also develops visual perception, fine motorskills, the ability to locate categorize and draw conclusions.

Activity Board

A colorful board is provided with many different visual, tactile and auditory activities with a range of sounds and volumes. It encourages motor movement, co-ordination and sensory skills.

Scents Board

A scents board is provided for enabling smell related activities to be experienced by the child.

This unique activity uses the smell sense, enabling the child a special experience of investigation and identification of scents to be matched with the icon appearing on the box. This activity improves categorizing and matching skills, while developing imagination through the strong sense of smell.

Mirrors Activity Column

In this embodiment of the invention, several types of mirrors are provided, including convex, concave, distorting mirrors, magnifying mirrors, deformable mirrors, diminishing mirrors, multiple mirrors etc.

The embodiment provides fascinating, entertaining and fun activity enabling children to explore their reflection in front of different types of mirrors, thereby understanding the concept of what is a mirror and how its structure influences what they see through it.

Hand and Foot Textures Game Board

In this embodiment of the invention, different textures are provided on a board.

Using the sense of touch, children will experience and differentiate between various types of textures with their hands and then find the matching texture on the floor using their hands and feet.

The Music Corner—Play, Explore, Produce Sounds, Listen & Enjoy Music

In the early stage of childhood, it is important to expose the child to the exciting world of music in order to help him develop his ability to distinguish between sounds.

In the Music Corner the child is exposed to different sound stimuli, which differ from one another in level, intensity and nuance of sound. The child is stimulated and challenged in his investigation of different instruments and his understanding of the relationship between musical sounds.

Through the interactive Comfy station presenting the software “Comfy's Joy of Music” placed in this corner, we expose the child to different instruments, enabling him to become familiar and to recognize the sounds and thereby developing his ability to listen.

Another example of an activity provided in this corner includes the Ethnics Instruments Board. This also includes maracas made of natural materials taken from the surroundings, enabling the child a different experience in producing varied sounds. Percussion instruments made of natural material are provided where the child can experience producing different sound levels, according to the strength of his playing.

Rainmaker Sticks/Tubes

A unique board including rainmaker sticks/tubes is provided, enabling the child to independently produce special sounds. The different rainmaker tubes in various lengths and materials produce various sounds creating both visual and audible stimulus.

Ethnic Instruments Board

Various ethnic musical instruments are provided on a board, enabling the child to indulge in a unique experience in producing a variety of sounds.

Maracas made of natural materials taken from our surroundings are provided as are other percussion instruments made of natural material. The child can produce different levels of sounds according to the strength of his playing.

Xylophone Board

Xylophone-like instruments providing wonderful sounds when tapping with the special stick. This activity enhances eye-hand coordination, exercises force adjustment and teaches the child the connection between powerful tap and powerful sound. The Xylophone opens up a variety of low to high sounds before the child and their level of appearance as a musical instrument.

Bells Board

A selection of high quality, genuine and colorful bells are provided, enabling the child to explore the various sounds and enhancing creativity through independent play. With this board the child can produce different beautiful sounds and enjoy the music he creates.

Percussion Boxes Board

This board includes 5 professional percussion boxes, offering endless musical creativity.

The child can independently play various sounds, in different rhythms, exploring his natural curiosity and deepening his knowledge of the music world.

Computer Stands with Musical Software

Special software games are provided teaching musical concepts by inviting the child to actively participate in the rehearsals and concert of the animated musical instruments. This is an ideal way for children to learn about musical instruments, become familiar with the idea of harmony and improve their fine and gross motor skills as well as their auditory skills.

The Cognitive Corner—Play, Think & Develop Varied Cognitive Skills.

In the early stage of childhood a child undergoes significant cognitive developments such as learning to speak and using symbols for thinking. At a second stage the child actively seeks explanations to what is around him. This refers to the mental process through which the world is perceived: how we define, remember, classify the vast amounts of information we receive; how we understand cause & effect; how we learn and draw conclusions; and how we set our imagination free. In this stage there is great motor development and enhancement of fine & gross motor skills. In the Cognitive Corner disclosed herein many varied activities have been provided, enabling the child to play and enjoy games that improve his cognitive abilities which are developing at this stage. Examples of such activities provided in the invention are:

Optical Spinners

The optical spinner is a colored circular panel for optical illusions and visual marvels. Using the sight sense, the child will be curious to explore the changes of how the spinner looks when still and when in motion. Through play, children will be able to find out how things look from different angles.

Telephone Recording Box

The attractive box records sounds and plays them back. Focusing on the hearing sense, this fun activity provides motivation for communication skills enhancement, enabling fun self-interaction or parent/friends interactive activity all together.

“Buddy” Montessori

Through identification with the lovable Comfy bear character, the child will use his sense of touch and cognitive thinking to experience different activities such as opening/closing of a zipper, shoelaces, buttons etc. These activities combine fine motor skills for 2 age groups: 1-2 year old and 2-3 year old.

An example of a cognitive activity included in this corner is Comfy's Matching Game. The board is divided into two activities—matching Comfy's characters to their shadow and finding the opposites through Comfy's characters and objects taken from Comfy's world of contents.

3C Development Cycle is integrated into this approach of stimulating the child's curiosity—he wants to explore and understand what are the different switches and when does the light bulb light up. The activity challenges him to find the relevant character and its shadow and the right match of opposites.

This fun, experiential activity also enhances fine motor skills, the ability to identify & classify objects and helps in learning & understanding concepts.

Beads Game Board

A beads game board is provided to challenge the toddler in moving the beads from one side to the other. This activity is an exciting mission for a toddler. It requires good hand control, developed eye-hand coordination and planning as well as cognitive thinking. The game can be used independently by one child or as a joint fun game with friends.

Associations Game

A colorful designed board made of 5 cubes is provided. The child has to turn in them order to create the matching series of elements—all with the same world of content. This game helps the child to categorize objects, learn concepts and develop his cognitive thinking.

Jumpy's Maze

A beautiful maze is provided, taken from the animated world of Comfy where Jumpy, the dog, should find his way home to his kennel. In this activity the child will learn the aim of the game and will use his judgment on how to achieve it. This game develops the visual perception and fine motor skills, enabling the child to learn from his mistakes and reach his target.

Matching Shapes

In this embodiment of the invention, a colorful board is provided to the child who has to match the right shape to its equivalent place in the picture. The game endows learning and differentiating between shapes and improves visual perception plus observation and generalization abilities.

Memory Game Board

A well known memory game is herein disclosed using the friendly Comfy characters. The aim of the game is developing the child's concentration and memory. Its unique structure enhances fine motors killt through active play.

Matching Game Board

A fun, experiential board is provided, divided into two games—matching Comfy's characters to their shadows and finding opposites taken from Comfy's world of contents.

This activity also enhances fine motor skills, the ability to identify and classify objects and helps in learning and understanding concepts.

Comfy Cars

A wooden and colorful themed car is provided where children can sit and play with the Comfy Easy PC Learning System. The Easy PC is an interactive learning system for toddlers as young as 12 months. Comfy's educational and entertaining platform opens up a whole new world of interactive experiences. A unique keyboard with large colorful buttons and friendly animated characters inspires and motivates effective learning. The specially designed software offers various levels of developmental learning that grows with the child, who will continuously enjoy and discover exciting and challenging activities.

The Right Activity Mix for a Complete Experience

The Comfyland Experience presents the right balance between technological interactive activities, physical interaction (through soft play) and cognitive voyage of investigation and exploration. The main interactive activities are experienced through the Comfy Easy PC stations including the Comfy car. The Comfy Car is a fun colorful wooden car where children can play with Comfy's various range of age-appropriate educational software.

Examples of activities which are similarly themed on screen and off include in a non limiting manner Examples 1-3 described below.

### EXAMPLE 1

An example of similarly themed musical activites is the following: The game “Joy of Music” exposes children to the wonderful world of music with animated fun characters. The child learns about different instruments, their sounds, rhythm and harmony. By pressing the color keys on the Comfy keyboard, children can actually play tunes and musical notes, creating a multi-sound ensemble. Through the interactive Comfy station located at the Music Corner, through the “Joy of Music” software, the child is exposed to different instruments, enabling him to become familiar, to recognize the sounds, thereby developing his ability to listen.

In the CEC center, a rich Music Corner is provided where children play, explore, produce sounds, listen and enjoy music. In the Music Corner the child is exposed to different sound stimuli, which differ from one another in level, intensity and nuance of sound. The child is challenged in his investigation of different instruments and his understanding of the relationship between musical relations. Hence there is a continuity of the essentially similar theme through on screen and off screen activities.

### EXAMPLE 2

An example of similarly themed cognitive activities is the following; the series of games “Animal World”, Time Travel” and “My Neighborhood” focus on developing cognitive abilities. For example, “Animal World” is an enriching experience where the child develops cognitive, emotional, language and creative skills through challenging stories, interactive games, creative arts and fun music activities. Examples of such activities in the game “animal world”: during this game, the children play with puzzles and match various animal pictures; they also hear different animal sounds and match the sounds to a specific animal.

In our CEC center, a Cognitive Corner has been provided where children play, think & develop varied cognitive skills through the rich activities.

An example of a cognitive activity included in this corner is Comfy's Matching Game. The board is divided into two activities—matching Comfy's characters to their shadow and finding the opposites through Comfy's characters and objects taken from Comfy's world of contents.

The child wants to explore and understand what the different switches are and the activity challenges him to find the relevant character and its shadow and the right match of opposites.

This fun, experiential activity also enhances the ability to identify & classify objects and helps in learning & understanding concepts.

### EXAMPLE 3

An example of similarly themed sensing activities is the following: The attractive Telephone Recording Box records sounds and plays them back. Focusing on the hearing sense, this fun activity provides motivation for communication skills enhancement, enabling fun self-interaction or parent/friends interactive activity all together.

The screen related game “Birthday Party” helps toddlers acquire social cleverness and tools of communication. In this game, children attain concepts in social interaction and communication skills through enjoyable and charming interactive stories. The children can call the characters on screen and help them achieve various goals online.

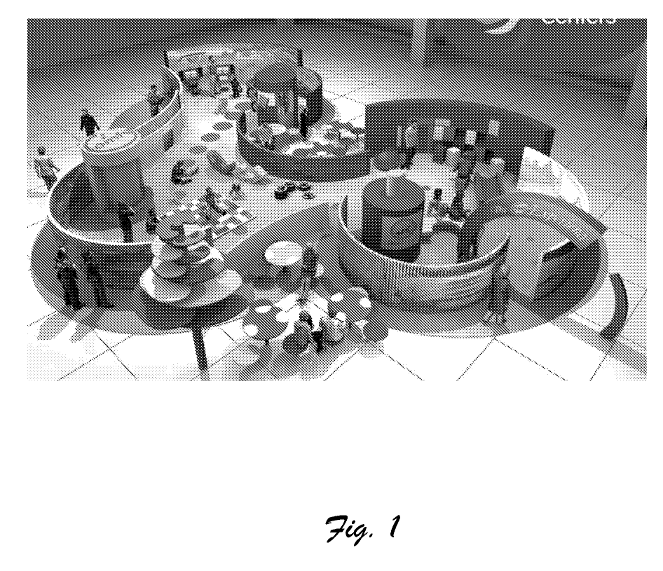

Reference is now made to FIG. 1 which is a photographic depiction of a preferred embodiment of the computerized content enriched environment for children.

Reference is made to the core of the invention wherein the child is stimulated by both on screen and off screen activities and experiences within the computerized content-enriched environment. It is acknowledged that the aforementioned core of the invention includes the preferred embodiment wherein the same “Comfy” theme characterizes the on-screen and off screen activities and experiences provided to the child. Without wishing to be bound by theory it has been postulated that the benefit to the child as he or she meets increasing challenges to curiosity with increasing confidence in the aforementioned way, via both on screen and off screen activities, may well be more than additive, when compared to the benefit accruing to the child through separately themed on-screen and off screen activities and experiences.

Reference is now made to a computerized content-enriched environment (CCEE) for children. The CCEE is adapted to increase challenges to curiosity (CTC) of said children, thereby increasing their confidence. The aforementioned CCEE comprises a plurality of themed interactive computerized stimulators, operators and sensors within a themed safe environment. Furthermore, the portion of the plurality of themed interactive computerized stimulators, operators and sensors mediate on screen activities in the CCEE and another portion of the plurality of themed interactive computerized stimulators, operators and sensors mediate off screen activities in the CCEE. In preferred embodiments of the CCEE the aforementioned themes are similar, and in other embodiments they are identical. In other embodiments of the invention the effect of providing a portion of the plurality of themed interactive computerized stimulators, operators and sensors for mediating on screen activities in the CCEE and providing another portion of the plurality of similarly or identically themed interactive computerized stimulators, operators and sensors for mediation of off screen activities in the CCEE is synergistically beneficial to the child.

Reference is now made to FIG. 1, illustrating a preferred embodiment of the invention. As shown, the computerized content-enriched environment (CCEE) for children contains corners of interest such as the Senses Corner, where interactions and activities involving the 5 senses are emphasized, the Music Corner, where interactions and activities involving producing, listening to and otherwise responding to music are emphasized, and the Cognitive Corner, where interactions and activities involving cognitive skills and abilities are emphasized. The corners are linked in an attractive maze-like structure, designed to draw the toddler's interest so that he or she is led from one corner to another.

Reference is now made to an embodiment of the invention, namely a computerized content-enriched environment (CCEE) for children, adapted to increase challenges to curiosity (CTC) of said children, thereby increasing their confidence. The invention comprises a plurality of interactive computerized stimulators, operators and sensors within a themed safe environment.

The above CCEE is further referred to wherein at least a portion of the plurality of computerized stimulators are operatable interactively in an iterative essentially spiral protocol of increasing CTCs such that increasing children confidence is provided.

Further reference is made to the CCEE wherein the CTCs are derived from themed protocols such that increasing children confidence is provided.

Further reference is made to the CCEE wherein the CTCs are divided by leveled parameters. These parameters are selected from a group consisting of age, developmental stage, physical condition or ability, communicative ability cognitive capacity, emotional state and/or mental parameters.

Yet further reference is made to the above mentioned CCEE wherein the levels for each parameter are either dependent or independent on each other.

Reference is now made to the abovementioned CCEE wherein the CTCs and said parameters are determined by means selected from a group consisting the children, his/her parents, a supervisor in any remote location or within the CCEE, or any preset computerized protocol.

Reference is now made to the abovementioned CCEE, wherein the plurality of interactive computerized stimulators are selected from a group consisting of display screens, lights and illuminating means, vibrating means, rocking means, audio means, video means, tactile means, olfactory means, test means, loud speakers, robots, toys, avatars, pets and pet-like modules, ball games and racquets thereof, vehicles, and maneuverable units.

Reference is now made to the abovementioned CCEE wherein the plurality of operators are selected from a group consisting of buttons, levers, keyboards, remote controls, sliders, touch screens, audio-operatable means, joy-sticks, steering wheels, handles, toggles and triggers.

Reference is now made to the abovementioned CCEE wherein the plurality of sensors are selected from a group consisting of temperature, vocal, weight, touch, impedance, light, volume detectors, vibration detectors and accelerometers.

Reference is now made to the abovementioned CCEE, wherein the safe environment is provided with walls, gates, monitoring means, maze-like pathways; alarms, safety system, fireproofing modules, child identification means,

Reference is now made to the abovementioned CCEE wherein the safe environment is made of child-friendly, non-toxic fireproof light materials.

Reference is now made to the abovementioned CCEE, wherein the environment is made of interlinking & interlocking easily laid-out modules.

Reference is now made to the abovementioned CCEE wherein the themed environment comprises a plurality of corners. The corners are selected in a non-limiting manner from a group consisting of music, sports, cognitive, senses, animals, adventure, comic heroes, syndicated and branded heroes, science, domestic activates, hospital, police, army.

Reference is now made to the abovementioned CCEE wherein the CTC are ranked in difficulty.

Reference is now made to the abovementioned CCEE wherein the children are one or more identities selected from a group consisting of children, toddlers, physically or mentally impaired persons, coordination impaired persons, communication impaired persons, ADDs, ADHDs, PDDs, elder persons, individuals suffering from Alzheimer-like symptoms.

Reference is now made to a method of providing a computerized content-enriched environment (CCEE) for children, comprising steps of: obtaining a safe environment; arranging a plurality of themed interactive computerized stimulators, operators and sensors within the environment; interactively and operating a plurality of stimulators, operators and sensors in an iterative essentially spiral protocol of increasing CTCs; such that children experiencing said environment, increase their confidence.

Reference is now made to the abovementioned method further comprising step of ranking said CTCs in order of difficulty.

Reference is now made to the abovementioned method further comprising step of challenging said child according to appropriate levels, said levels are function of parameters; said parameters selected from a group consisting of age, developmentally, physically, communicatively cognitively, emotionally and/or mentally parameters.

Further reference is now made to the abovementioned method, wherein selecting the level for each parameter is either dependent or independent upon each parameter.

Lastly, reference is made to the abovementioned method wherein the step of obtaining a safe environment is provided by interlinking & interlocking easily laid-out modules.

1. A computerized content-enriched environment (CCEE) for children, adapted to increase challenges to curiosity (CTC) of said children, thereby increasing their confidence; comprising a plurality of themed interactive computerized stimulators, operators and sensors within a themed safe environment wherein a portion of said plurality of themed interactive computerized stimulators, operators and sensors mediate on screen activities in said CCEE and a portion of said themed plurality of stimulators, operators and sensors mediate off screen activities in said CCEE further wherein said themes are essentially similar or identical for both said on screen and said off screen stimulators, operators and sensors.

2. The CCEE of claim 1, wherein said content enriched environment comprises a plurality of corners selected from a group comprising senses corner, music corner and cognitive corner.

3. The CCEE of claim 2, wherein said senses corner comprises a plurality of items selected from a group consisting of: a cupboard with several compartments, said compartments containing articles composed of different materials and textures; a board provided with manipulable articles some of which emit sounds; a board provided with smell emitting items; a column provided with several types of mirrors including convex, concave, distorting mirrors, magnifying mirrors, deformable mirrors, diminishing mirrors, multiple mirrors etc.; and a Hand and Foot Textures Game Board provided with tactile objects.

4. The CCEE of claim 2 wherein said music corner comprises a plurality of items selected from a group consisting of Rainmaker Sticks/Tubes, Ethnic Instruments Board, Xylophone Board, Bells Board, Percussion Boxes Board, and Computer Stands with Musical software.

5. The CCEE of claim 2 wherein said cognitive corner comprises a plurality of items selected from a group consisting of Optical Spinners, Telephone Recording Box, “Buddy” Montessori, Beads Game Board, Associations Game, Jumpy's Maze, Matching Shapes, Memory Game Board, Matching Game Board and Comfy Cars.

6. The CCEE of claim 1, wherein at least a portion of said plurality of stimulators are operatable interactively in an iterative essentially spiral protocol of increasing CTCs such that increasing children confidence is provided.

7. The CCEE of claim 1, wherein said CTCs are derived from themed protocols such that increasing children confidence is provided.

8. The CCEE of claim 1, wherein said CTCs is divided by leveled parameters; said parameters are selected from a group consisting of age, developmentally, physically, communicatively cognitively, emotionally and/or mentally parameters.

9. The CCEE of claim 8, wherein said level for each parameter are either dependent or independent of each other.

10) The CCEE of claim 8, wherein said CTCs and said parameters are determined by means selected from a group consisting the children, his/her parents, a supervisor in any remote location or within said CCEE, or any preset computerized protocol.

11) The CCEE of claim 1, wherein said plurality of stimulators are selected from a group consisting of display screens, lights and illuminating means, vibrating means, rocking means, audio means, video means, tactile means, olfactory means, test means, loud speakers, robots, toys, avatars, pets and pet-like modules, ball games and racquets thereof, vehicles, maneuverable units,

12) The CCEE of claim 1, wherein said plurality of operators are selected from a group consisting of buttons, levers, keyboards, remote controls, sliders, touch screens, audio-operatable means, joy-sticks, steering wheels, handles, triggers,

13) The CCEE of claim 1, wherein said plurality of sensors are selected from a group consisting of temperature, vocal, weight, touch, impedance, light, volume detectors, vibration detectors, accelerometers,

14) The CCEE of claim 1, wherein said safe environment is provided with walls, gates, monitoring means, maze-like pathways; alarms, safety system, fireproofing modules, child identification means,

15) The CCEE of claim 1, wherein said safe environment is made of child-friendly, non-toxic fireproof light materials.

16) The CCEE of claim 1, wherein said environment is made of interlinking & interlocking easily laid-out modules.

17) The CCEE of claim 1, wherein said themed environment comprises a plurality of corners, said corners are selected in a non-limiting manner from a group consisting of music, sports, cognitive, senses, animals, adventure, comic heroes, syndicated and branded heroes, science, domestic activates, hospital, police, army,

18) The CCEE of claim 1, wherein said CTC are ranked in difficulty.

19) The CCEE of claim 1, wherein said increase in confidence is synergistically enhanced when said themes are essentially similar or identical compared with said increase in confidence when said themes are essentially different.

20) The CCEE of claim 1, wherein said children are one or more identities selected from a group consisting of children, toddlers, physically or mentally impaired persons, coordination impaired persons, communication impaired persons, ADDs, ADHDs, PDDs, elder persons, individuals suffering from Alzheimer-like symptoms.

21) A method of providing a computerized content-enriched environment (CCEE) for children, comprising steps of:
obtaining a safe environment;
arranging a plurality of themed interactive computerized stimulators, operators and sensors within said environment; a portion of said plurality of themed interactive computerized stimulators, operators and sensors mediating on screen activities in said CCEE and a portion of themed plurality of interactive stimulators, operators and sensors mediating off screen activities in said CCEE
interactively operating said plurality of said stimulators, operators and sensors in an iterative essentially spiral protocol of increasing CTCs; such that children experiencing said environment, increase their confidence.

22) The method of claim 21, further comprising step of ranking said CTCs in order of difficulty.

23) The method of claim 21, further comprising step of challenging said child according to appropriate levels, said levels are function of parameters; said parameters selected from a group consisting of age, developmentally, physically, communicatively cognitively, emotionally and/or mentally parameters.

24) The method of claim 21, wherein selecting said level for each parameter is either dependent or independent upon each parameter.

25) The method of claim 21, wherein said children are one or more identities selected from a group consisting of children, toddlers, physically or mentally impaired persons, coordination impaired persons, communication impaired persons, ADDs, ADHDs, PDDs, elder persons and individuals suffering from Alzheimer-like symptoms.

26)The method of claim 21, wherein said step of obtaining a safe environment is provided by interlinking & interlocking easily laid-out modules.
